(19) United States
(12) Patent Application Publication
(10) Pub. No.: US 2024/0121234 A1
(43) Pub. Date: Apr. 11, 2024

(54) Ascertaining an Evaluation of a Data Set

(71) Applicant: Siemens Aktiengesellschaft, München (DE)

(72) Inventors: Marco Kiehle, Lauf an der Pegnitz, Bayern (DE); Markus Rascher, Neunkirchen a. Br. (DE)

(73) Assignee: Siemens Aktiengesellschaft, München (DE)

(21) Appl. No.: 18/263,996

(22) PCT Filed: Jan. 28, 2022
(86) PCT No.: PCT/EP2022/052121

§ 371 Date: Aug. 2, 2023

(30) Foreign Application Priority Data
Feb. 3, 2021 (DE) 10 2021 200 995.6

(51) Int. Cl. H04L 9/40; H04L 41/16; H04L 43/04

(52) U.S. Cl. CPC H04L 63/0823; H04L 41/16; H04L 43/04

(57) ABSTRACT

Various embodiments of the teachings herein include a method for ascertaining an evaluation BEW of a data set DS made available to a client by a data source in a data packet D. The method may include: analyzing the data packet D using the client to determine a group GCHAR of characteristics CHAR_i, where i=1, . . . , n and where n≥1, typical of the data packet DS; and ascertaining the evaluation BEW of the data set on the basis of the determined characteristic CHAR1, CHAR2 with the aid of already available information.

### CROSS-REFERENCE TO RELATED APPLICATIONS

This application is a U.S. National Stage Application of International Application No. PCT/EP2022/052121 filed Jan. 28, 2022, which designates the United States of America, and claims priority to DE Application No. 10 2021 200 995.6 filed Feb. 3, 2021, the contents of which are hereby incorporated by reference in their entirety.

### TECHNICAL FIELD

The present disclosure relates to data management. Various embodiments of the teachings herein include methods and/or systems for ascertainment of an evaluation of a data set in a data packet, in particular on the basis of one or more characteristics of the data set.

### BACKGROUND

With increasing conductivity of devices, for example in the field of the “Internet-of-Things” (IoT), data and/or values are being shifted within companies. Data and connections are transmitted and set up, respectively, beyond physical boundaries and sometimes beyond national borders, with the result that activities and services based on the data can be provided entirely in an automated manner and also locally at other locations. Although the assessment or other further processing of the transferred data does not rarely follow predefined processes and/or processes which are already tried and tested per se, such data-based actions are still often carried out manually in a complicated manner and sometimes in a manner that is not consistent. This leads to process execution that is not very efficient and scarcely reproducible and therefore not very reliable.

### SUMMARY

Teachings of the present disclosure include methods and systems that can be used to automatically ascertain an evaluation of a data set provided by a data source, with the result that further measures can finally be initiated on the basis of the evaluation ascertained in this manner. For example, some embodiments include a computer-implemented method for ascertaining an evaluation BEW of a data set DS made available to a client (20) by a data source (10) in a data packet D, wherein the data packet D is analyzed by the client (20) in a first method step V1 to the effect that a group GCHAR of characteristics CHAR_i, where and where n≥1, that are typical of the data packet DS is determined, said group comprising at least one characteristic CHAR_i, and in a second method step V2, the evaluation BEW of the data set is ascertained on the basis of the at least one determined characteristic CHAR1, CHAR2 with the aid of already available information.

In some embodiments, at least one of the characteristics CHAR1 to be ascertained in the first method step V1 is a data pattern DSMUS, wherein the data set DS is analyzed in the first method step V1 by the client (20) in a pattern identification method step V1_MUS of the first method step V1 with regard to the presence of a particular data pattern DMUS_m from a multiplicity of previously known data patterns GDMUS with the aim of identifying one of the previously known data patterns DMUS_m in the data set DS.

In some embodiments, the data packet D comprises the data set DS to be evaluated and at least one output parameter DA of the data source (10), wherein at least one of the characteristics CHAR2 to be ascertained in the first method step V1 is based on a context DSKXT of the data set DS, wherein the context DSKXT is ascertained in a step V1_SEL_KXT of a selection method step V1_SEL of the first method step V1 on the basis of the at least one output parameter DA of the data source (10), and the evaluation BEW of the data set DS is carried out in the second method step V2 on the basis of the identified data pattern DSMUS and the ascertained context DSKXT.

In some embodiments, the data packet D comprises the data set DS to be evaluated and at least one output parameter DA of the data source (10), wherein at least one of the characteristics CHAR2 to be ascertained in the first method step V1 represents a suitable information source INFO_KXT for ascertaining the evaluation BEW, which information source is configured to assign an evaluation BEW to a data pattern DMUS_m, wherein the suitable information source INFO_KXT is ascertained in a step V1_SEL_INFO of a selection method step V1_SEL of the first method step V1 on the basis of the at least one output parameter DA of the data source (10), the evaluation BEW of the data set DS is carried out in the second method step V2 on the basis of the identified data pattern DSMUS and the ascertained suitable information source INFO_KXT.

In some embodiments, in the selection method step V1_SEL of the first method step V1, the context DSKXT of the data set DS is first of all ascertained in the step V1_SEL_KXT on the basis of the at least one output parameter DA of the data source (10), and the at least one suitable information source INFO_KXT is then ascertained in the step V1_SEL_INFO on the basis of the ascertained context DSKXT.

In some embodiments, the suitable information source INFO_KXT, in the step V1_SEL_INFO on the basis of the at least one output parameter DA, is selected from a predefined group GINFO of information sources INFO_q, wherein a respective information source INFO_q in the group GINFO respectively assigns a predetermined evaluation BEW to one or more of the previously known data patterns DMUS_m, or is ascertained using an artificial neural network KNN25 which is configured and trained to output a suitable information source INFO_KXT on the basis of a context DSKXT or output parameter DA supplied to the network KNN25.

In some embodiments, one of the output parameters DA is an identity ID10 of the data source (10), wherein the identity ID10 of the data source (10) is determined by first of all checking whether the data source (10) is trustworthy, in particular on the basis of an identity check using a digital certificate, if the data source (10) is trustworthy, ascertaining the identity of the data source (10) on the basis of centrally saved information and/or on the basis of information transmitted by the data source (10).

In some embodiments, one of the output parameters DA is a spatial origin LOC10 of the data set DS, wherein the origin LOC10 of the data set DS is determined on the basis of centrally saved information and/or on the basis of information transmitted by the data source (10), in particular geo-tagging information.

In some embodiments, one of the output parameters DA is a predefined use of the data set DS or a specific predefined context DSKXT of the data set DS.

In some embodiments, the ascertained evaluation BEW represents a financial value of the data packet DS.

As another example, some embodiments include a system for ascertaining an evaluation BEW of a data set DS made available to a client (20) of the system in a data packet D, having a data analyzer (23) which is configured to carry out one or more elements of the methods described herein.

In some embodiments, the data analyzer (23) has an artificial neural network which is configured to ascertain the evaluation BEW of the data set DS on the basis of the ascertained data pattern DSMUS and the ascertained context DSKXT.

### BRIEF DESCRIPTION OF THE DRAWINGS

The teachings of the present disclosure and exemplary embodiments thereof are explained in more detail below with reference to drawings. Possibly identical components are indicated in various figures there using identical reference signs. It is therefore possible that more detailed explanations are not found in the description of a second figure for a particular reference sign which has already been explained in connection with another, first figure. In such a case, it can be assumed for the embodiment in the second figure that the component indicated there using this reference sign has the same properties and functionalities as explained in connection with the first figure, without a more detailed explanation in connection with the second figure. Furthermore, for the sake of clarity, not all reference signs are sometimes shown in all figures, but rather only those to which reference is made in the description of the respective figure.

In the drawings:

FIG. 1 shows an architecture of a data source and a client, between which a data packet is transmitted incorporating teachings of the present disclosure; and

FIG. 2 shows a schematic illustration of an example method for ascertaining the evaluation BEW incorporating teachings of the present disclosure.

### DETAILED DESCRIPTION

Various embodiments of the teachings herein include a computer-implemented method, with the aid of which the evaluation BEW of data can be ascertained in a reproducible manner. The method is accordingly used to ascertain such an evaluation BEW of a data set DS made available to a client by a data source in a data packet D. In this case, the data packet D is analyzed by the client in a step V1 to the effect that a group GCHAR of characteristics CHAR_i, where i=1, . . . , n and where n≥1, that are typical of the data set DS is determined, said group comprising at least one characteristic. In step V2, the evaluation BEW of the data set DS is ascertained on the basis of the at least one determined characteristic with the aid of corresponding information that is already available from the past.

At least one of the characteristics CHAR1 to be ascertained in the step V1 is a data pattern DSMUS. The data set DS is analyzed in the step V1 by the client, that is to say by means of appropriate software implemented on a client computer, in a pattern identification step V1_MUS of the step V1 with regard to the presence of a particular data pattern DMUS_m from a multiplicity of previously known data patterns GDMUS with the aim of identifying one of the previously known data patterns DMUS_m in the data set DS that has been provided, therefore resulting in the identified data pattern DSMUS=DSMUS_m. Data patterns may be, for example, error codes or particular temporal behaviors within particular time windows.

The data packet D comprises the data set DS to be evaluated and at least one output parameter DA of the data source. At least one of the characteristics CHAR2 to be ascertained in the step V1 is based on a context DSKXT of the data set DS, wherein the context DSKXT is ascertained in a step V1_SEL_KXT of a selection step V1_SEL of the step V1 on the basis of the at least one output parameter of the data source. The evaluation BEW of the data set DS is hereby carried out in the step V2 on the basis of the identified data pattern DSMUS and the ascertained context DSKXT and may also be ascertained in this case, for example, as that evaluation BEW which is output by an accordingly trained artificial neural network when the context DSKXT and the data pattern DSMUS are supplied.

If the data packet D comprises the data set DS to be evaluated and at least one output parameter DA of the data source, at least one of the characteristics CHAR2 to be ascertained can represent a suitable information source INFO_KXT for ascertaining the evaluation BEW, which information source is configured to assign an evaluation BEW to a data pattern DMUS_m, wherein the suitable information source INFO_KXT is ascertained in a step V1_SEL_INFO of a selection step V1_SEL of the step V1 on the basis of the at least one output parameter DA of the data source. The evaluation BEW of the data set DS is then carried out in the step V2 on the basis of the previously identified data pattern DSMUS and the ascertained suitable information source INFO_KXT and is ascertained in this case as that evaluation BEW which is assigned to the identified data pattern DSMUS by the suitable information source INFO_KXT. In this case, it is fundamentally conceivable for a plurality of information sources to be selected, with the result that more than one information source is included in the ascertainment of the evaluation.

In the selection step V1_SEL of the step V1, the context DSKXT of the data set DS is first of all ascertained in this case in the step V1_SEL_KXT on the basis of the at least one output parameter DA of the data source. The at least one suitable information source INFO_KXT is then ascertained in the step V1_SEL_INFO on the basis of the ascertained context DSKXT.

The suitable information source INFO_KXT, in the step V1_SEL_INFO on the basis of the at least one output parameter and possibly on the basis of the previously ascertained context DSKXT, can either be selected from a predefined group GINFO of information sources INFO_q, wherein a respective information source INFO_q in the group GINFO respectively assigns a predetermined evaluation BEW to one or more of the previously known data patterns DMUS_m, or can be ascertained using an artificial neural network KNN25 which is configured and trained to output a suitable information source INFO_KXT on the basis of a context DSKXT or output parameter DA supplied to the network KNN25.

Different information sources INFO_q may be, for example, different files which are stored or saved in a corresponding data memory on a server or the like or such different files which are stored in different data memories. In this case, the different data memories may be provided by different operators.

One of the output parameters DA may be, for example, an identity ID10 of the data source, wherein the identity ID10 of the data source is determined by first of all checking whether the data source is trustworthy, in particular on the basis of an identity check using a digital certificate, for example X.509. If the data source is trustworthy, that is to say if the check has revealed that the data source is trustworthy, the identity ID10 of the data source is defined on the basis of centrally saved information, for example information saved in a cloud environment, and/or on the basis of information transmitted by the data source.

In some embodiments, one of the output parameters DA may be a spatial origin LOC10 of the data set, that is to say for example a location of the data source, wherein the origin LOC10 of the data set is determined on the basis of centrally saved information and/or on the basis of information transmitted by the data source, in particular geo-tagging information.

In some embodiments, one of the output parameters DA may be a predefined use of the data set or a specific predefined context DSKXT of the data set, with the result that the ascertainment of the context in the step V1_SEL_KXT is reduced to reading out the predefined context and there is therefore a higher degree of certainty or reliability of the evaluation ascertainment.

In other words, various embodiments of the teachings of the present disclosure include a computer-implemented method for ascertaining an evaluation of a data set DS made available to a client by a data source in addition to at least one output parameter DA of the data source. In some embodiments, the data set DS is analyzed by the client in the first method step V1 in the pattern identification method step V1_MUS of the method itself initially with regard to the presence of a data pattern DSMUS from a multiplicity of previously known data patterns in order to identify one of the previously known data patterns in the data set DS that has been provided. The context DSKXT of the data set DS is also ascertained in the selection method step V1_SEL on the basis of one or more output parameters DA of the data source. At least one suitable information source INFO_KXT is selected from a predefined group of information sources on the basis of the ascertained context DSKXT, wherein a respective information source in the group respectively assigns a predetermined evaluation BEW to one or more of the previously known data patterns. The actual evaluation BEW of the data set BS is finally ascertained on the basis of the identified data pattern DSMUS from the selected information source INFO_KXT as that evaluation BEW which is assigned to the identified data pattern DSMUS there.

A corresponding system for ascertaining an evaluation BEW of a data set made available to a client of the system by a data source in a data packet has a data analyzer which is configured to carry out the described method comprising the step V1 and the step V2.

In some embodiments, the data analyzer includes an artificial neural network which is configured and pre-trained to ascertain the evaluation BEW of the data set on the basis of the ascertained data pattern DSMUS and the ascertained context DSKXT. The evaluation BEW ascertained with the system using the method can provide, for example, information relating to the extent to which the data set DS in the data packet D can be trusted and whether it is reliable, with the result that reliable decisions can consequently be made.

Depending on the context DSKXT, the evaluation BEW of the data set DS may be of a different nature or may comprise different aspects. Ultimately, the ascertained evaluation BEW of the data set DS can be understood, for example, as a measure of the relevance of the value during a particular planned use of the evaluated data set DS, for example for training artificial neural networks by using the evaluation BEW to weight the data DS for training the network, or for determining the state of an industrial installation and also in entirely different fields, for example for calculating prices, costs or taxes when transferring the evaluated data set.

Again in the case of the use for training an artificial neural network, the evaluation BEW of the data set DS could be determined by how representative of the subsequent use of the artificial neural network the data set DS is. The artificial neural network is intended for certain uses, for example for identifying particular objects in an image. In that case, a valuable data set DS could comprise labeled images which show at least some objects which are of interest for the use. However, if the images comprise only objects which are not of interest, this is not entirely worthless for training the artificial neural network, but the evaluation BEW is lower than for the data set DS with the first-mentioned images. A data set DS may therefore be weighted differently when training the artificial neural network depending on the ascertained evaluation BEW.

If the evaluation BEW is used to determine the state of an industrial installation, the data set DS is analyzed and, depending on the result of the analysis, that is to say depending on the ascertained evaluation of the data set DS, the state of the installation is inferred, for example “normal” or “defective”. In this case, an industrial installation may also already be, for example, an individual machine which operates as a component of an IoT architecture.

In a further use, a company, for example, may form a tax base for digitally provided activities and services and may therefore minimize an existing tax risk. In this use case of the evaluation BEW of the data set DS as a financial value, this value BEW may be used, for example, to set a price for transmitting the data set DS from a first user to a second user, that is to say a type of purchase price, or to determine tax burdens possibly associated with the transmission etc.

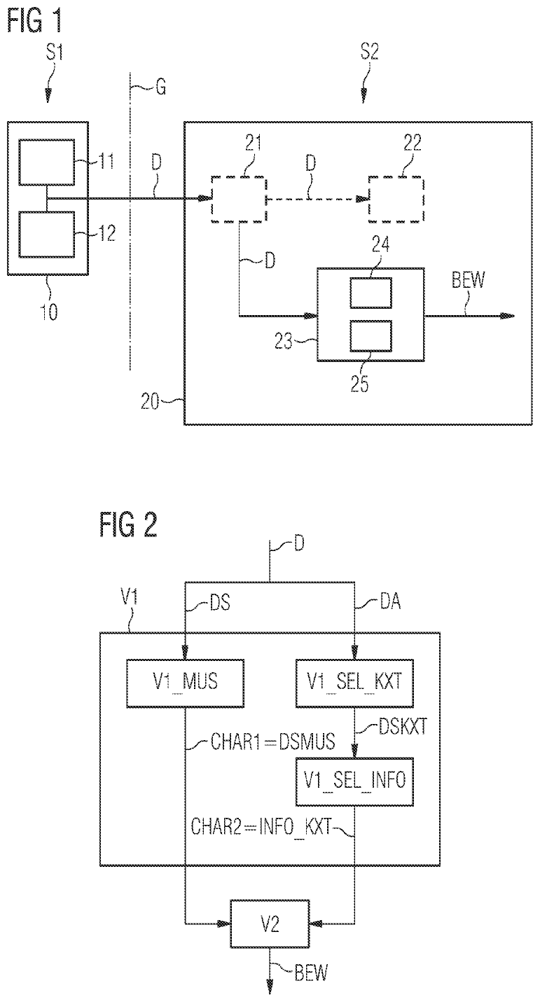

FIG. 1 shows, by way of example and in a simplified manner, a situation in which a data source 10 transmits a data packet D={DA,DS}, comprising a data set DS and one or more output parameters DA, to a client 20. In this case, the data source 10 and the client 20 may be situated at different locations S1, S2, for example in different countries, with the result that the data are possibly also transferred beyond national borders G. The data source 10 and the client 20 may each be in the form of a data center, a cloud service or the like, for example.

The data source 10 may have, for example, an IoT device 11 and further source devices 12 which each send data packets D from the location S1 to the client 20 at the location S2, where a user (not separately illustrated), for example an operator, a service engineer, another user or a control system or the like, remotely uses or assesses the respective data packet D provided, for example in order to monitor, control and/or maintain the IoT device 10 or to further process the data provided in the data packet D for any purpose. It is also possible, for example, to carry out remote services or predictive maintenance on the basis of information from the data D, wherein said user is selected and trained in accordance with the planned use of the data packets D.

The data packets D provided are received by the client 20 at the location S2. The client 20 is configured to ascertain an evaluation BEW of a respective data packet D. For example, if the data packets D are intended to be processed in one of the further services mentioned by way of example above, symbolized in FIG. 1 by the optional function 22 that is therefore symbolized by a dashed line, the client 20 may have an accordingly likewise optional data broker 21 which diverts the data packets D received by the client 20 or copies thereof, for example, to a data analyzer 23 which ascertains the evaluation BEW. The data broker 21 may be integrated in a reverse proxy, for example. If no further use of the data packets D is envisaged apart from ascertaining the evaluation BEW of the data packets D, it is possible to dispense with the function 22 and also the data broker 21, and the data packets D pass directly to the data analyzer 23 after being received by the client 20.

The method for ascertaining the evaluation BEW, which is carried out by the data analyzer 23, also requires, in addition to the data set DS contained in the data packet D, the output parameter(s) DA likewise provided there, as explained below and illustrated in FIG. 2. Information from a pattern database 24 and from an information database 25 is also required, wherein the pattern database 24 and/or the information database 25 may be integrated in the data analyzer 23 or organized separately, for example centrally in a cloud.

In a step V1 carried out by the data analyzer 23, the data packet D is first of all analyzed to the effect that a group GCHAR of characteristics CHAR1, . . . , CHARn, where n≥1, that are typical of the data packet is determined. The group GCHAR therefore comprises at least one such characteristic CHAR1. It is assumed below that the group GCHAR comprises two characteristics CHAR1, CHAR2.

In this case, the first characteristic CHAR1 is a pattern DSMUS that can be recognized in the data set DS. The pattern DSMUS may be, for example, an error code or other recognizable data behaviors, for example particular temporal behaviors within a respective time window. If data are therefore transmitted within a particular time window with a particular pattern or in a particular order, for example, this may be representative of a particular service case, for example, and the data set DS should be evaluated accordingly.

In a first, simple rule-based variant for determining or recognizing the pattern DSMUS, the data set DS in the data packet D is analyzed in a pattern identification method step V1_MUS of the step V1 with respect to the presence of a particular data pattern DMUS_m from a multiplicity of previously known data patterns GDMUS={DMUS_1, DMUS_2, . . . , DMUS_M}, where M≥1, with the aim of identifying one of the previously known data patterns DMUS_m, where 1111M, from GDMUS in the data set DS provided, that is to say it is determined that DSMUS=DMUS_m. In some embodiments, the previously known data patterns DMUS_m of the multiplicity GDMUS are saved in the already mentioned pattern database 24. The data set DS to be analyzed is compared with the previously known patterns from GDMUS. That pattern DMUS_m from the multiplicity of previously known patterns GDMUS which is most similar to the data set DS is defined as the correct pattern DSMUS and is therefore defined as the first characteristic CHAR1=DSMUS=DMUS_m.

In a second, more flexible embodiment for determining or recognizing the pattern DSMUS in the pattern identification method step V1_MUS which is likewise carried out here, the pattern database 24 is in the form of a pre-trained artificial neural network KNN24. The network KNN24 is configured to recognize a data pattern DSMUS=DSMUSknn in a data set DS that is supplied to it and is to be analyzed and to make this pattern DSMUS available to the data analyzer 23, with the result that CHAR1=DSMUS=DSMUSknn applies at the end in the second variant. The use of an artificial neural network KNN24 allows the data pattern DSMUS to be ascertained even for data patterns which have hitherto not been known in the data set DS.

The network KNN24 may be trained in a conventional manner in advance, for example using artificial or real data sets DS, for which the patterns DSMUS occurring therein are already known. The data sets DS are labeled with their respectively known patterns DSMUS for the training and the network KNN24 is trained using these labeled data sets in a manner known per se.

Summarizing this, the step V1 provides, both in the first variant and in the second variant of its pattern identification method step V1_MUS, the first characteristic CHAR1 which represents a data pattern DSMUS in the data set DS. As mentioned, in addition to the first characteristic CHAR1, the first method step V1 ideally also provides a second characteristic CHAR2 which is determined in a selection method step V1_SEL of the first method step V1. In this case, the second characteristic CHAR2 is an information source INFO to be used by the data analyzer 23 to ascertain the evaluation BEW, that is to say CHAR2=INFO.

In order to identify this information source INFO, a context DSKXT of the data set DS is first of all determined in the selection method step V1-SEL in a step V1_SEL_KXT, wherein this context DSKXT is ascertained on the basis of the at least one output parameter DA of the data packet D. The context DSKXT may be, for example, a use of the data set DS that is planned by the client 20 or is predefined by the data source 10, and/or may describe, for example, the backgrounds for generating the data set DS. If, for example, the data source 10 is a nuclear power plant and the data set DS represents current operating parameters of the power plant, the context DSKXT could be the operational safety of the power plant and the evaluation BEW is a measure of the reliability of the transmitted data DS. In the use case for ascertaining taxes, as mentioned at the outset, the context DSKXT would be precisely this use and the evaluation would be a financial value of the data set DS.

The output parameter(s) DA of the data packet D may be, for example, metadata relating to the generation and/or an envisaged use or assessment of the data set DS in the client 20 and may accordingly be written into the data packet D by the data source 10 before transmission to the client 20. For example, one of the possible plurality of output parameters DA for ascertaining the context DSKXT may represent an identity ID10 of the data source 10, wherein the identity ID10 is determined in the step V1_SEL_KXT by first of all checking whether the data source 10 is trustworthy, for example by means of an identity check using a digital certificate, for example X.509. If the data source 10 is trustworthy, that is to say if the check has revealed that the data source 10 is trustworthy, the identity ID10 of the data source 10 is ascertained on the basis of information saved centrally in a cloud or the like, for example, and/or on the basis of information transmitted by the data source 10.

In some embodiments, one of the possible plurality of output parameters DA for ascertaining the context DSKXT may be a spatial origin LOC10 of the data set 10, that is to say, for example, the location S1 of the data source 10, wherein the origin of the data set DS can again be determined in the step V1_SEL_KXT on the basis of centrally saved information and/or on the basis of information transmitted by the data source 10, for example geo-tagging information.

If the identity ID10 and/or the origin LOC10 is/are known, the context DSKXT corresponding to this situation LOC10, ID10 can be read, for example, from a corresponding assignment table which respectively assigns a context to different combinations of ID10 and/or LOC10.

In some embodiments, one of the possible plurality of output parameters DA may likewise be a use of the data set DS which is specifically predefined by the data source 10. It is likewise conceivable for the output parameter(s) DA to already comprise the context DSKXT itself to be used. On the basis of the context DSKXT of the data set DS that has been ascertained in this manner in the step V1_SEL_KXT on the basis of the identity ID10 and/or location LOC10 of the data source 10 and/or possibly further information contained in the output parameters DA, the information source INFO=INFO_KXT suitable for ascertaining the evaluation BEW is selected in a subsequent step V1_SEL_INFO of the selection method step V1_SEL.

In a first, simple rule-based variant for selecting the information source INFO_KXT on the basis of the context DSKXT, the suitable information source INFO_KXT is selected from an existing group GINFO={INFO_1, INFO_2, . . . , INFO_Q} of information sources INFO_q, where 1≤q≤0 and Q≥1. A respective information source INFO_q in the group GINFO respectively assigns a predetermined evaluation BEW to at least one, but typically to a multiplicity, of the previously known data patterns DMUS_m. In this case, it is entirely conceivable for different information sources INFO_q1, INFO_q2 to assign different evaluations BEW1, BEW1 to the same data pattern, for example DMUS1, which consequently means that different evaluations BEW1, BEW2 could be ascertained for the same data pattern DMUS_1 depending on the context. Different information sources INFO_q may be, for example, different files which are stored or saved in a corresponding data memory on a server or the like, or such different files which are stored in different data memories. In this case, the different data memories may be provided by different operators.

The previously known information sources INFO_q are saved in the already mentioned information database 25, wherein the information database 25 in this first variant assigns one of the information sources INFO_q to each conceivable context, for example in the form of a table, for example a so-called “look-up table” LUT. The information database 25 therefore provides the data analyzer 23 with a particular information source INFO_KXT, where 1≤KXT≤Q, from the multiplicity of information sources INFO_q that is suitable for ascertaining the evaluation BEW when the ascertained context DSKXT is supplied. In this first variant, the information database 25 is constructed on the basis of experience from the past, that is to say for example on the basis of earlier assignments of suitable information sources to particular contexts.

In a second, more flexible embodiment for selecting the information source INFO_KXT on the basis of the context DSKXT in the step V1_SEL_INFO, the information database 25 is in the form of a pre-trained artificial neural network KNN25. The network KNN25 is configured to ascertain a suitable information source INFO_KXT for a context DSKXT supplied to it and to make this information source available to the data analyzer 23, with the result that CHAR2=INFO_KXT finally applies. The use of the artificial neural network KNN25 instead of the table LUT allows a suitable information source INFO_KXT to be ascertained even for contexts DSKXT which have hitherto not be known.

The network KNN25 may also have been trained in a conventional manner in advance, for example on the basis of artificial or real contexts, for which it is known which information source is most suitable for finally ascertaining the evaluation BEW. The contexts are labeled with a suitable information source for the training, and the network KNN25 is trained using these labeled contexts in a manner known per se.

In summary, the step V1 therefore provides a first characteristic CHAR1=DSMUS and a second characteristic CHAR2=INFO_KXT. The pattern identification method step V1_MUS for determining CHAR1 and the selection method step V1_SEL for determining CHAR2 can be carried out in the first method step V1 at the same time or in succession in any desired order. Only the steps V1_SEL_KXT and V1_SEL_INFO of the selection method step V1_SEL must necessarily be carried out in succession since the step V1_SEL_INFO requires the result from the step V1_SEL_KXT.

In a step V2 which follows the step V1 and is carried out by the data analyzer 23, the definitive evaluation BEW of the data set DS is ascertained on the basis of the characteristics CHAR1=DSMUS and CHAR2=INFO_KXT with the aid of information from the past that is already available in the selected information source INFO_KXT. Specifically, the evaluation BEW assigned to the pattern DSMUS is identified in the selected information source INFO_KXT and is assigned to the data set DS to be evaluated as the evaluation.

At least two variants for ascertaining the evaluation BEW are also conceivable at this point. In a first, simple variant, a predetermined evaluation BEW is respectively assigned to each data pattern DMUS_m in a respective information source INFO_q, as already described above, for example in the form of a corresponding table. In a second, more flexible variant, it is also conceivable here to use an artificial neural network KNN which ascertains the evaluation BEW on the basis of the data pattern DSMUS and information source INFO_KXT supplied to it or, alternatively, on the basis of the data pattern DSMUS and context DSKXT supplied to it.

In some embodiments, the method for ascertaining the evaluation BEW of the data set DS therefore assumes that the evaluation BEW depends on the context DSKXT and on the pattern DSMUS of the data set DS in the data packet D. In a more flexible configuration, the data analyzer 23 may be in the form of an artificial neural network KNN23, with the result that some or even all of the individual steps V1, V1_MUS, V1_SEL, V1_SEL_KXT, V1_SEL_INFO and/or V2 described above are no longer carried out separately as individual steps, but rather are represented in a common calculation carried out by the KNN23.

For the step V1_MUS in particular, it may be advantageous to carry it out with the aid of the network KNN24, as already described, since it cannot be precluded that the pattern DSMUS cannot always be readily clearly recognized in the data set DS. In such cases, it may be helpful to use an artificial neural network. The use of an artificial neural network may also be advantageous for the selection method step V1_SEL comprising the substeps V1_SEL_KXT and V1_SEL_INFO, which network determines the suitable information source INFO_KXT solely on the basis of the output parameter(s) DA, without having to separately carry out the intermediate step for ascertaining the context DSKXT.

In the most comprehensive configuration in which KNN23 completely represents V1 and V2, including the respective substeps V1_MUS and V1_SEL, KNN23 requires, as input data, the data set DS and the output parameters DA in order to ascertain the evaluation BEW. The training of an accordingly designed artificial neural network which carries out the respectively planned steps or substeps may be carried out as already described above for KNN24 and KNN25 and is fundamentally oriented to the approaches which are known per se for training artificial neural networks.

Technical use cases for the method presented here for ascertaining the evaluation BEW of a data set DS and for the further use of the evaluation BEW itself have already been mentioned above. One further use arises from the fact that the evaluation BEW actually represents a financial value of the data set or of the data packet D. This use is advantageous, in particular, when the data packet D is transmitted beyond the indicated national border G, and so taxation on the basis of the value of the data becomes necessary. The proposed method makes it possible to ascertain values in such scenarios in an automated and therefore reproducible and also efficient manner.

What is claimed is:

1. A method for ascertaining an evaluation BEW of a data set DS made available to a client by a data source in a data packet D, the method comprising:
analyzing the data packet D using the client to determine a group GCHAR of characteristics CHAR_i, where i=1, . . . , n and where n≥1, typical of the data packet DS; and
asserting the evaluation BEW of the data set on the basis of the determined characteristic CHAR1, CHAR2 with the aid of already available information.

2. The method as claimed in claim 1, wherein:
at least one of the characteristics CHAR1 to be ascertained is a data pattern DSMUS;
the data set DS is analyzed by the client in a pattern identification step V1_MUS with regard to the presence of a particular data pattern DMUS_m from a multiplicity of previously known data patterns GDMUS with the aim of identifying one of the previously known data patterns DMUS_m in the data set DS.

3. The method as claimed in claim 2, wherein:
the data packet D comprises the data set DS to be evaluated and an output parameter DA of the data source;
at least one of the characteristics CHAR2 is based on a context DSKXT of the data set DS,
the context DSKXT is ascertained on the basis of the at least one output parameter DA of the data source; and
the evaluation BEW of the data set DS is carried out on the basis of the identified data pattern DSMUS and the ascertained context DSKXT.

4. The method as claimed in claim 2, wherein:
the data packet D comprises the data set DS to be evaluated and an output parameter DA of the data source;
at least one of the characteristics CHAR2 represents a suitable information source INFO_KXT for ascertaining the evaluation BEW, the information source configured to assign an evaluation BEW to a data pattern DMUS_m,
the suitable information source INFO_KXT is ascertained on the basis of the output parameter DA of the data source; and
the evaluation BEW of the data set DS is carried out on the basis of the identified data pattern DSMUS and the ascertained suitable information source INFO_KXT.

5. The method as claimed in claim 2, wherein:
the context DSKXT of the data set DS is ascertained on the basis of the output parameter DA of the data source; and
the suitable information source INFO_KXT is then ascertained on the basis of the ascertained context DSKXT.

6. The method as claimed in claim 4, wherein:
the suitable information source INFO_KXT, on the basis of the at least one output parameter DA,
is selected from a predefined group GINFO of information sources INFO_q; and
wherein a respective information source INFO_q in the group GINFO respectively assigns a predetermined evaluation BEW to one or more of the previously known data patterns DMUS_m, or
is ascertained using an artificial neural network KNN25 which is configured and trained to output a suitable information source INFO_KXT on the basis of a context DSKXT or output parameter DA supplied to the network KNN25.

7. The method as claimed in claim 3, wherein:
one of the output parameters DA comprises an identity ID10 of the data source;
the identity ID10 of the data source is determined by:
checking whether the data source is trustworthy, and,
if the data source is trustworthy, ascertaining the identity of the data source on the basis of centrally saved information and/or on the basis of information transmitted by the data source.

8. The method as claimed in claim 3, wherein one of the output parameters DA is a spatial origin LOC10 of the data set DS, wherein the origin LOC10 of the data set DS is determined on the basis of centrally saved information and/or on the basis of information transmitted by the data source, in particular geo-tagging information.

9. The method as claimed in claim 3, wherein one of the output parameters DA comprises a predefined use of the data set DS or a specific predefined context DSKXT of the data set DS.

10. The method as claimed in claim 1, wherein the ascertained evaluation BEW represents a financial value of the data packet DS.

11. A system for ascertaining an evaluation BEW of a data set DS made available to a client of the system in a data packet D, the system comprising:
a data analyzer configured to:
analyze the data packet D using the client to determine a group GCHAR of characteristics CHAR_i, where i=1, . . . , n and where n≥1, typical of the data packet DS; and
ascertain the evaluation BEW of the data set on the basis of the determined characteristic CHAR1, CHAR2 with the aid of already available information.

12. The system as claimed in claim 11, wherein the data analyzer further comprises an artificial neural network configured to ascertain the evaluation BEW of the data set DS on the basis of the ascertained data pattern DSMUS and the ascertained context DSKXT.
